(19) United States
(12) Patent Application Publication
(10) Pub. No.: US 2018/0169518 A1
(43) Pub. Date: Jun. 21, 2018

(54) Method for Transcribing Live Board Games Using Video Capturing and Machine Vision

(71) Applicant: Logical Innovation LLC, Las Vegas, NV (US)

(72) Inventors: Alexander Byron Lehmann, FULLERTON, CA (US); Vitaly Ziskin, NEWTON, MA (US); Claudiu Saftoiu, EL MONTE, CA (US)

(21) Appl. No.: 15/844,476

(22) Filed: Dec. 15, 2017

Related U.S. Application Data
(60) Provisional application No. 62/434,613, filed on Dec. 15, 2016.

(51) Int. Cl. A63F 13/213; A63F 13/33; A63F 13/95

(52) U.S. Cl. CPC A63F 13/213; H04N 5/775; A63F 13/95; A63F 13/33

(57) ABSTRACT

A method for transcribing life board games using video capturing and machine vision is disclosed. A new automatic system removes the need for a human being by using software running on a computing platform. This method allows for broadcasting the position of a live board game instead of live pictures of a board, thus significantly reducing the bandwidth requirement.

### RELATED APPLICATIONS

The subject matter of this application is related to U.S. Provisional Application No. 62/434,613, filed on 15 Dec. 2016, which is hereby incorporated by reference in its entirety.

### BACKGROUND OF THE INVENTION

Currently there is no way to automatically transcribe live board games for future analysis or computer replay. The board games are recorded on video and then transcribed by a human being. As such there is no way to provide real time analysis and computer assistance.

No such automatic system exists. Currently the board games are captured on video and later transcribed by a human. The live board games are transmitted via video feed resulting in high bandwidth demand. The video feeds, as such, unreliable especially in the regions where internet is limited.

The new automatic system removes the need for a human being by using a software running on a computing platform. It used machine vision algorithm to automatically transcribe the games in real time and provides real time position information which can be transmitted with a significantly lower bandwidth demand than video.

### SUMMARY OF THE INVENTION

A method for transcribing live board games includes a video capture device capturing live board games; a computing device executing a machine vision process, the machine vision process analyzing video captured by the video capture device; and the computing device generating electronic position data based on the analyzing.

The method can also include the video capture device sending the captured video to the computing device for analysis and position transcription, wherein the computing device is remotely located relative to the video capture device.

In one aspect, the video capture device is attached to the computing device.

The method can also include sending a board position string to a remote cloud storage and computing device.

The method can also include sending the board position string to at least one remote computer.

The method can also include the remote computer converting the board position string to a graphical position representation.

### BRIEF DESCRIPTION OF THE DRAWINGS

FIG. 1 illustrates a system and associated method in accordance with one embodiment

FIG. 2 illustrates an example user interface for the system and method in accordance with one embodiment.

FIG. 3 illustrates an example illustration of a game board image with graphical augmentations indicating computer machine vision recognized game pieces.

FIG. 4 illustrates a general computer architecture that can be appropriately configured to implement components disclosed in accordance with various embodiments.

### DETAILED DESCRIPTION

In the following description, references are made to various embodiments in accordance with which the disclosed subject matter can be practiced. Some embodiments may be described using the expressions one/an/another embodiment or the like, multiple instances of which do not necessarily refer to the same embodiment. Particular features, structures or characteristics associated with such instances can be combined in any suitable manner in various embodiments unless otherwise noted.

As stated above, currently there is no way to automatically transcribe live board games for future analysis or computer replay. The board games are recorded on video and then transcribed by a human being. As such there is no way to provide real time analysis and computer assistance. The invention claimed here solves this problem.

We use machine vision and machine learning algorithms in combination with video capture technology to automatically capture board position and play situations. The machine vision algorithms running on either local or remote computer analyze video stream and provide machine readable description of the position, for example but not limited to, position of checkers on the backgammon board and the dice roll.

The claimed invention differs from what currently exists. Using machine vision algorithms obviates the need for labor intensive human involvement saving on time and cost. It allows for real-time game analysis and computer assistance.

This invention is an improvement on what currently exists. Using machine vision algorithms obviates the need for labor intensive human involvement saving on time and cost. It allows for real-time game analysis and computer assistance. The remote users can view the live board game in real time on their workstations with the help of the computer game board rendering software, without the need to for bandwidth consuming live video feeds.

It is very labor intensive and cannot be done in real time. The video feeds take up significant bandwidth resulting in unreliable and delayed video feeds.

The new automatic system removes the need for a human being by using a software running on a computing platform. It used machine vision algorithm to automatically transcribe the games in real time and provides real time position information which can be transmitted with a significantly lower bandwidth demand than video.

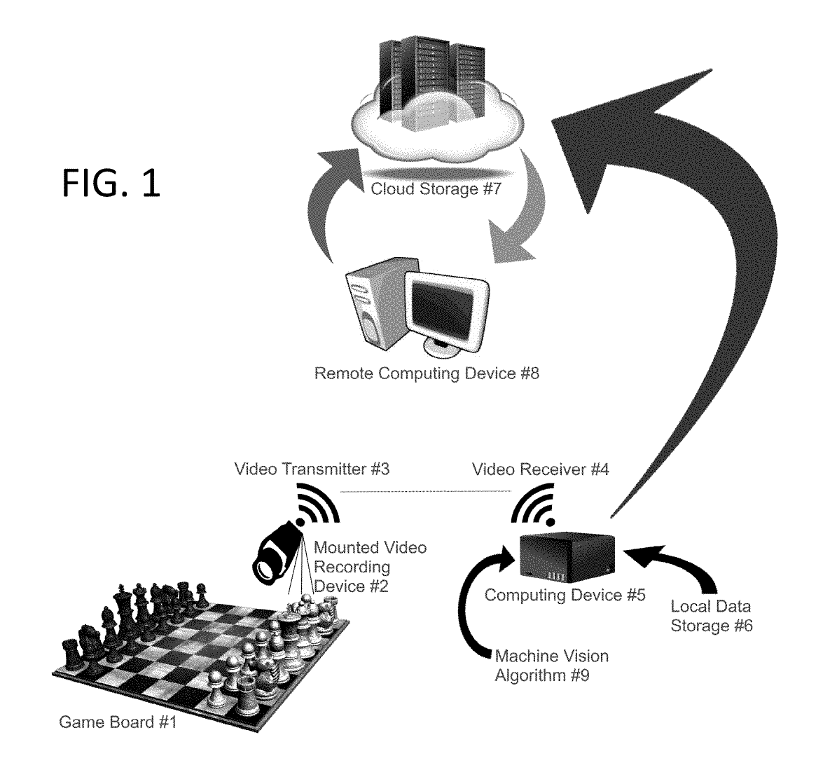

FIG. 1 illustrates a system and associated method in accordance with one embodiment. The system includes:
1. Game board with game pieces placed on it
2. A video recording device with mounting
3. Video transmission device
4. Video receiving device
5. Computing device
6. Data storage
7. Secondary cloud storage
8. Secondary remote computing devices
9. Machine vision algorithm

Relationship Between the Components:

The video recording device #2 records the position on the game board #1. The transmission device #3 send image frames to the video receiving device #4, which is attached to the computing device #5. The computing device #5 (such as PC computer, smart phone, etc.) using machine vision algorithms #9 to understand the board position in each frame and transcribe it into a computer readable data. The data is stored locally on the storage device #6 and transmitted to the secondary cloud storage device #7. The cloud storage device #7 is configured to provide board position to other remotely connected secondary computing devices #8, while the game is being played.

How the Invention Works:

The game board #1 is any board on which the game pieces are moved by one or many players according to some set of rules (for example backgammon, chess, etc.).

The video recording device #2 is camera enabled device, which creates images in digital format.

The video transmission and receiving devices #3 and #4 can be connect to each other over Wi-Fi, Bluetooth or any other wireless or wired protocol.

The computing device #5 receives video receiving device #4 feeds it to the machine vision algorithm. The machine vision algorithms #9, previously trained to a large set of possible board positions, identifies the position in each video frame by analysis the digital image.

The resulting position is encoded into the computer readable data and stored on local data storage device #6.

In some applications the video capturing device #2 is mounted on the same platform as the computing device #5 and storage device #6. in this case the video transmission and receiving devices #3 and #4 are not necessary for the system to work.

The data is also transmitted to the cloud storage device #7. The cloud storage is enabled to provide the position data to one or more remote computing devices #8, for additional storage, rendering to the screen on a visual format or other applications.

How to Make the Invention:

The key to make the invention work is to use machine vision algorithms #9 to recognize board position in real time. The recognition is based on the machine learning algorithms that enable the software to learn large number of positions and choose the correct position based on a set of rules taught to the software during the learning phase.

Additionally, a set of image processing algorithms are applied to the raw image captured by the image recording device #2 in order to convert image into shape and format used during machine learning stage.

Necessary elements are the board with game pieces #1, image capturing devices #2, computing device #5, machine vision algorithms #9 and storage device #6.

The optional elements are video transmission and receiving device #3 and #4, cloud storage device #7 and remove computing devices #8.

The video capture of the board game can be first placed on the storage device and then the machine vision algorithms can be used to transcribe the game positions in each frame either during or sometime after the game.

How to Use the Invention:

A person would set up the system prior to the start of the game and turn on the system as the game starts. He would establish the connection between the transmission and receiving devices. She would also establish the connection between the computing device and the cloud storage device as well as the connection between the cloud storage device and the remote computing devices.

Additionally: Instead of the game board position, the system can be used for example to recognize relative positions of micro bodies captured with a digital microscope.

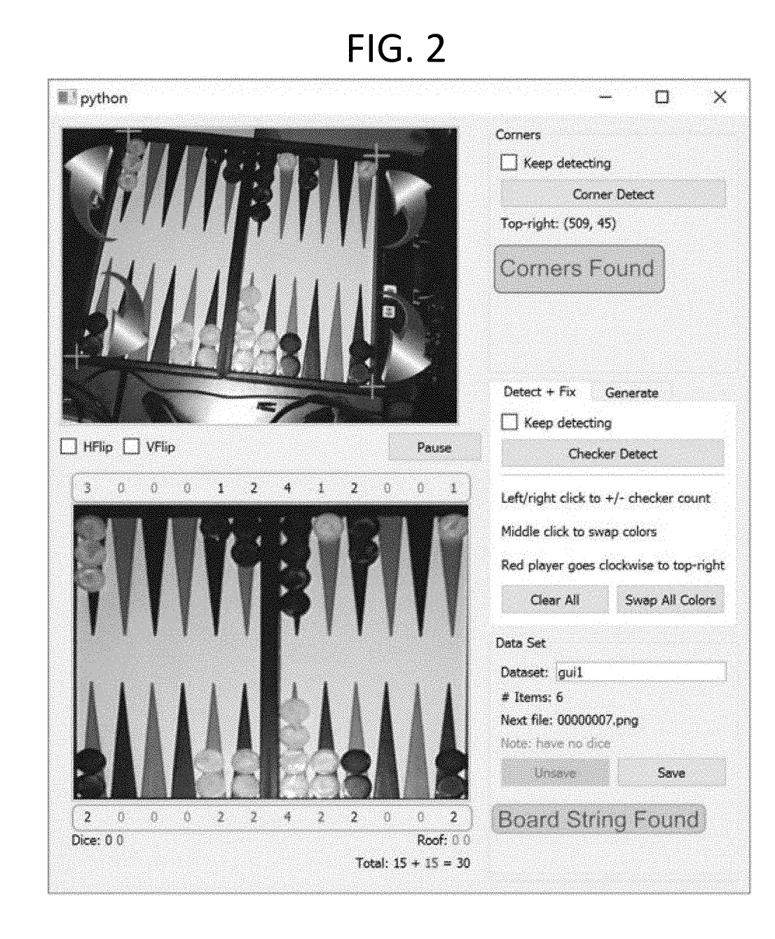

FIG. 2 illustrates an example user interface for the system and method in accordance with one embodiment.

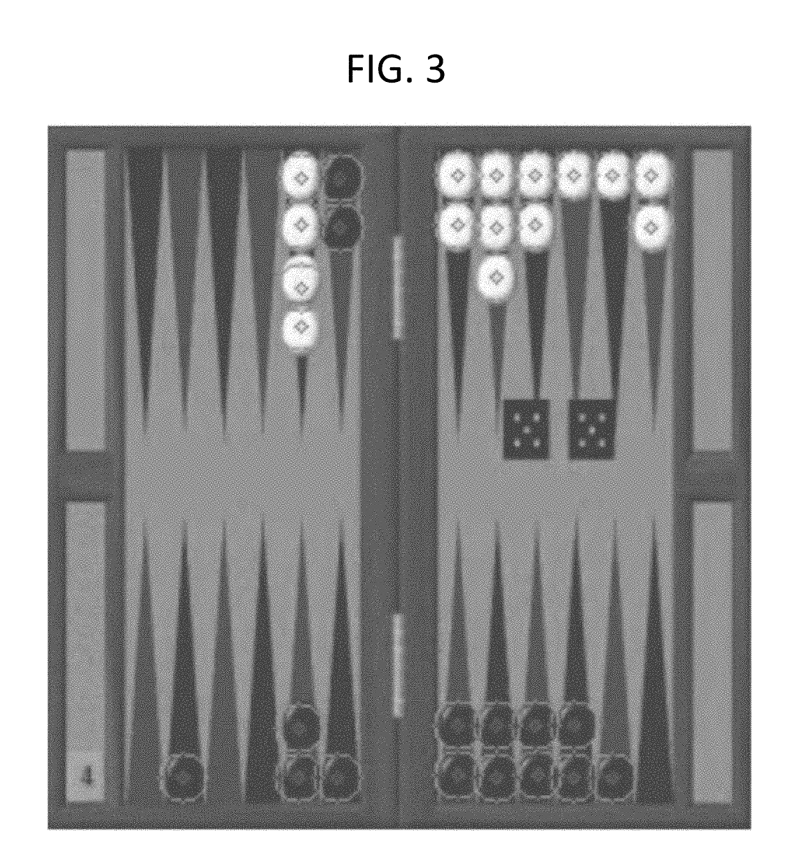

FIG. 3 illustrates an example illustration of a game board with graphical augmentations indicating computer machine vision recognized game pieces.

Computer Implementation

Components of the embodiments disclosed herein, which may be referred to as methods, processes, applications, programs, modules, engines, functions or the like, can be implemented by configuring one or more computers or computer systems using special purpose software embodied as instructions on a non-transitory computer readable medium. The one or more computers or computer systems can be or include standalone, client and/or server computers, which can be optionally networked through wired and/or wireless networks as a networked computer system.

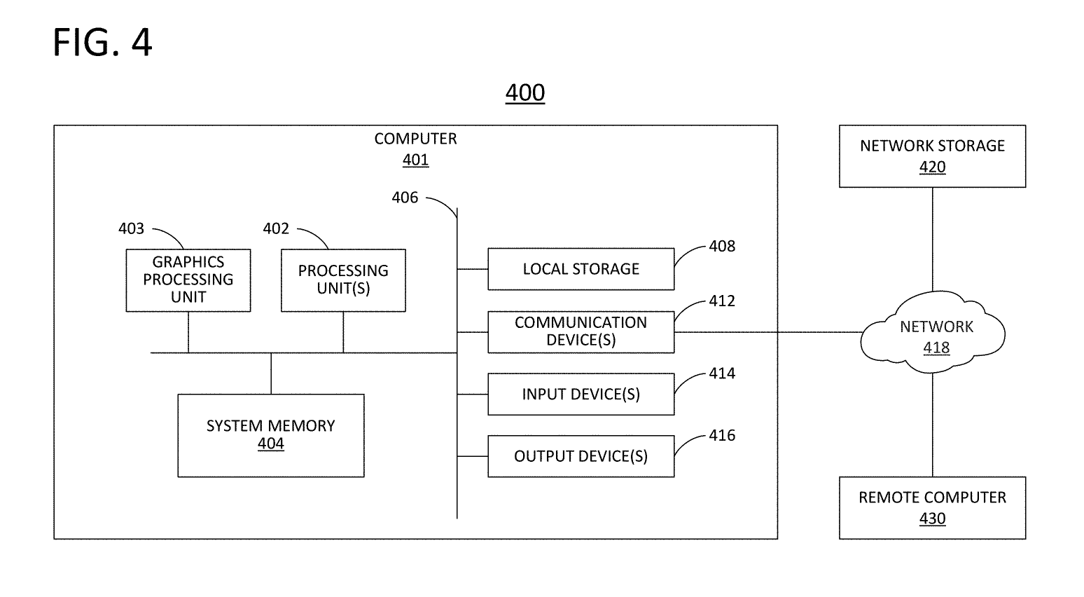

FIG. 4 illustrates a general computer architecture 400 that can be appropriately configured to implement components disclosed in accordance with various embodiments. The computing architecture 400 can include various common computing elements, such as a computer 401, a network 418, and one or more remote computers 430. The embodiments disclosed herein, however, are not limited to implementation by the general computing architecture 400.

Referring to FIG. 4, the computer 401 can be any of a variety of general purpose computers such as, for example, a server, a desktop computer, a laptop computer, a tablet computer or a mobile computing device. The computer 401 can include a processing unit 402, a system memory 404 and a system bus 406.

The processing unit 402 can be any of various commercially available computer processors that can include one or more processing cores, which can operate independently of each other. Additional co-processing units, such as a graphics processing unit 403, also can be present in the computer.

The system memory 404 can include volatile devices, such as dynamic random access memory (DRAM) or other random access memory devices. The system memory 404 can also or alternatively include non-volatile devices, such as a read-only memory or flash memory.

The computer 401 can include local non-volatile secondary storage 408 such as a disk drive, solid state disk, or removable memory card. The local storage 408 can include one or more removable and/or non-removable storage units. The local storage 408 can be used to store an operating system that initiates and manages various applications that execute on the computer. The local storage 408 can also be used to store special purpose software configured to implement the components of the embodiments disclosed herein and that can be executed as one or more applications under the operating system.

The computer 401 can also include communication device(s) 412 through which the computer communicates with other devices, such as one or more remote computers 430, over wired and/or wireless computer networks 418. Communications device(s) 412 can include, for example, a network interface for communicating data over a wired computer network. The communication device(s) 412 can include, for example, one or more radio transmitters for communications over Wi-Fi, Bluetooth, and/or mobile telephone networks.

The computer 401 can also access network storage 420 through the computer network 418. The network storage can include, for example, a network attached storage device located on a local network, or cloud-based storage hosted at one or more remote data centers. The operating system and/or special purpose software can alternatively be stored in the network storage 420.

The computer 401 can have various input device(s) 414 such as a keyboard, mouse, touchscreen, camera, microphone, accelerometer, thermometer, magnetometer, or any other sensor. Output device(s) 416 such as a display, speakers, printer, eccentric rotating mass vibration motor can also be included.

The various storage 408, communication device(s) 412, output devices 416 and input devices 414 can be integrated within a housing of the computer, or can be connected through various input/output interface devices on the computer, in which case the reference numbers 408, 412, 414 and 416 can indicate either the interface for connection to a device or the device itself as the case may be.

Any of the foregoing aspects may be embodied in one or more instances as a computer system, as a process performed by such a computer system, as any individual component of such a computer system, or as an article of manufacture including computer storage in which computer program instructions are stored and which, when processed by one or more computers, configure the one or more computers to provide such a computer system or any individual component of such a computer system. A server, computer server, a host or a client device can each be embodied as a computer or a computer system. A computer system may be practiced in distributed computing environments where operations are performed by multiple computers that are linked through a communications network. In a distributed computing environment, computer programs can be located in both local and remote computer storage media.

Each component of a computer system such as described herein, and which operates on one or more computers, can be implemented using the one or more processing units of the computer and one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

Components of the embodiments disclosed herein, which may be referred to as modules, engines, processes, functions or the like, can be implemented in hardware, such as by using special purpose hardware logic components, by configuring general purpose computing resources using special purpose software, or by a combination of special purpose hardware and configured general purpose computing resources. Illustrative types of hardware logic components that can be used include, for example, Field-programmable Gate Arrays (FPGAs), Program-specific Integrated Circuits (ASICs), Program-specific Standard Products (ASSPs), System-on-a-chip systems (SOCs), and Complex Programmable Logic Devices (CPLDs).

Although the subject matter has been described in terms of certain embodiments, other embodiments, including embodiments which may or may not provide various features and advantages set forth herein will be apparent to those of ordinary skill in the art in view of the foregoing disclosure. The specific embodiments described above are disclosed as examples only, and the scope of the patented subject matter is defined by the claims that follow.

1. A method for transcribing live board games comprising:
a video capture device capturing live board games;
a computing device executing a machine vision process, the machine vision process analyzing video captured by the video capture device; and
the computing device generating electronic position data based on the analyzing.

2. The method of claim 1, further comprising:
the video capture device sending the captured video to the computing device for analysis and position transcription, wherein the computing device is remotely located relative to the video capture device.

3. The method of claim 1, wherein the video capture device is attached to the computing device.

4. The method of claim 1, further comprising:
sending a board position string to a remote cloud storage and computing device.

5. The method of claim 4, further comprising:
sending the board position string to at least one remote computer.

6. The method of claim 5, further comprising:
the remote computer converting the board position string to a graphical position representation.
